(19) United States
(12) Patent Application Publication
(10) Pub. No.: US 2004/0141633 A1
(43) Pub. Date: Jul. 22, 2004

(54) Intruding object detection device using background difference method

(75) Inventor: Daisaku Horie, Uji-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/413,662

(22) Filed: Apr. 15, 2003

(30) Foreign Application Priority Data
Jan. 21, 2003 (JP) 2003-012436 (P)

(51) Int. Cl. G06K 9/00; H04N 7/18

(52) U.S. Cl. 382/103; 348/152

(57) ABSTRACT

In an intruding object detection device which performs a background difference process, the following processings are carried out in order to increase the precision in detecting an object. A region where there is high possibility that an intruding object exists is detected from a reference image and an image (in this case, an image to be corrected) captured by a camera in a background difference process. Errors such as a deviation in the image-capturing position between the reference image and the captured image are corrected by affine transformation. The amount of deviation is calculated while excluding the region where there is high possibility that an intruding object exists. This enables appropriate deviation correction, thereby enhancing high precision in detecting an object.

This application is based on Japanese Patent Application No. 2003-12436 filed with Japan Patent Office on Jan. 15, 2003, the entire content of which is hereby incorporated by reference.

### BACKGROUND OF THE INVENTION

1. Field of the Invention

The present invention relates to an intruding object detection device and, more particularly, to an intruding object detection device for detecting an intruding object by using a background difference method.

2. Description of the Related Art

There is a well-known system in which a camera is used for the purposes of monitoring intruders, counting the number of moving people, determining the presence or absence of a person, acquiring states of the operator of the device, and cutting out a character's region for character identification.

For such purposes, character extraction intended for intruders or moving people is carried out. The character extraction utilizes a background difference method in many cases. In the background difference method, an image which does not contain a subject to be detected is acquired as a reference image. A subject extraction is carried out on the basis of the difference between an input image from a camera at each point in time and the reference image.

There is also a time difference method of carrying out subject detection on the basis of the difference between two images different in time. This aims at detecting a moving object between two images.

FIG. 32 is an illustration for describing a process by the time difference method.

As shown in the figure, time-series images to be detected are captured by a camera at the same position. Assuming that the images were captured at time T1, T2 and T3, respectively, the difference image T2−T1 between the image at T1 and the image at T2, and the difference image T3−T2 between the image at T2 and the image at T3 are found. These difference images are used to detect the presence or absence of an intruding object and its position.

FIG. 33 is an illustration for describing a process by the background difference method.

As shown in the figure, a background (also referred to as “reference image”) S which becomes a detecting target at the image-capturing position is acquired. Images are captured by a camera at time T1, T2 and T3, and difference images T1−S, T2−S, and T3−S between reference image S and the captured images are obtained. These difference images can be used to detect the presence or absence of an intruding object and its position.

The background difference method differs from the time difference method in that not a motion but the intrusion of an object to the reference image is detected. The background difference method also differs from the time difference method in that a frame difference is found not between time-series images which are comparatively consecutive in time but between two images which are not consecutive in the time direction. Thus, the background difference method has different features from the time difference method.

The background difference method has the following problems.

First, deterioration of the camera or wind may cause the position of the image captured at the current time to be deviated from the original position where the reference image has been captured, which may result in incorrect detection.

As shown in the left side of FIG. 34, an intruding object can be detected correctly when there is no deviation in the image-capturing position between the image captured at the current time and the reference image. On the other hand, as shown in the right side of FIG. 34, when there is a deviation in the image-capturing position between the image captured at the current time and the reference image, a difference value is detected from a region not containing an intruding object. As a result, there is a problem that this region is mistakenly detected as an intruding object.

As shown in the left side of FIG. 35, an intruding object can be detected correctly when there is no change of in illumination condition between the image captured at the current time and the reference image. On the other hand, as shown in the right side of FIG. 35, when there is a change of in illumination condition between the image captured at the current time and the reference image, there is a problem that an intruding object is mistakenly detected due to the variation of the illumination conditions.

Image processing technique related to the present invention is disclosed in the following references.

Japanese Laid-Open Patent Publication No. 9-114977 discloses a technique of specifying an intruding object region by calculating normalizing correlation for each local region. This technique, however, is not an intruder detection method considering a positional deviation, but regards an illumination change as the only cause of detection errors. Another drawback of this technique is that since the intruder detection is carried out by correlation calculation, the performance in intruder detection is not sufficient for the purpose of silhouette detection which is to be performed separately and correctly when there is a plurality of intruding objects.

Japanese Laid-Open Patent Publication No. 7-298247 discloses a monitoring method and a monitoring system using a TV camera. This is a technique of detecting the motion of a subject by motion vectors. This technique, however, intends to perform framing in correspondence with the motion of the subject, and is not a technique of cutting out a moving object region correctly.

Japanese Laid-Open Patent Publication No. 11-120363 discloses a monitoring and threatening device. This is a technique of performing moving object detection for each local region and of integrating information about the results of motion detection within the neighboring local regions in the time direction and the positional direction, so as to designate the moving object region at the current time.

This patent publication contains a description about the detection of scene changes; however, when such a change is detected, there is only a rough division of detection between the presence or absence of an illumination change and the presence or absence of a moving object. This technique is considered to aim at avoiding mistakenly detecting an illumination change as a moving object, and is not related to cutting out a moving object region correctly when there is a minor positional deviation.

There have been conventional techniques related to the detection of a camera shake while taking a motion film, and to motion vector detection for a subject. However, it has not been considered to correct the positional deviation of the background in detecting an intruding object on the basis of the background difference method on the precondition that the background does not move.

### SUMMARY OF THE INVENTION

The present invention has been achieved to solve the aforementioned problems, and it is an object thereof to provide an intruding object detection device capable of enhancing detection precision.

In order to achieve the object, an intruding object detection device according to an aspect of the present invention includes: a processing unit for correcting a deviation between a first image and a second image and for detecting an intruding object, on the basis of the difference between the first and second images from which the deviation has been corrected, wherein the first image is to be a reference image and the second image is different from the second image.

An intruding object detection method according to another aspect of the present invention includes the steps of: acquiring a reference image; acquiring an image different from the reference image; detecting a deviation between the reference image and the image different from the reference image; and detecting an intruding object from the reference image and the image different from the reference image by taking the detected deviation into consideration.

A program product according to still another aspect of the present invention makes a computer execute the steps of: acquiring a reference image; acquiring an image different from the reference image; detecting a deviation between the reference image and the image different from the reference image; and detecting an intruding object from the reference image and the image different from the reference image by taking the detected deviation into consideration.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram for describing the principle of the image processing system in a first embodiment of the present invention.

FIG. 2 is a block diagram showing the structure of the image processing system in the first embodiment of the present invention.

FIG. 3 is an illustration for describing the environments in which the image processing system is used.

FIG. 4 is an illustration for describing an example of driving a camera.

FIG. 5 is an illustration showing images captured by the camera at different times.

FIG. 6 is an illustration showing images which follow in time the images shown in FIG. 5.

FIG. 7 is an illustration showing the outer appearance of a rotatable monitoring camera and errors in image capturing.

FIG. 8 is a view for describing a shock error.

FIG. 9 is a view for describing a positional deviation due to lens distortion.

FIG. 10 is a view for describing a rotation error in panning.

FIG. 11 is a view showing a process for excluding regions where there is high possibility that an intruding object exists (potential intruding object regions) from a matching target.

FIG. 12 is a view for describing a process for finding the inter-frame difference between a reduced image A′ and a reduced image B′.

FIG. 13 is a flowchart showing a process for intruding object detection according to the time difference method, which is carried out by a moving object detecting unit of a CPU-in-camera.

FIG. 14 is a flowchart showing a process carried out by an intruding object detecting unit of an external PC.

FIG. 15 is a flowchart showing the procedure of a registration correction process (S205) in FIG. 14.

FIG. 16 is a flowchart showing the procedure of a matching process (S303) in FIG. 15.

FIG. 17 is a flowchart showing the procedure of a possible intrusion region setting process (S403) in FIG. 16.

FIG. 18 is a flowchart showing a process (S505) for selecting five or less pixels in decreasing order of the size of the differential value shown in FIG. 17.

FIG. 19 is a flowchart showing the procedure of an approximate data calculating process (S405) in FIG. 16.

FIG. 20 is a flowchart showing the procedure of a deforming process (S305) in FIG. 15.

FIG. 21 is a flowchart showing the procedure of a background difference process (S207) in FIG. 14.

FIG. 22 is a block diagram showing the structure of an image processing system in a second embodiment of the present invention.

FIG. 23 is a block diagram showing the structure of an image processing system in a third embodiment of the present invention.

FIG. 24 is a block diagram for describing the principle of an image processing system in a fourth embodiment of the present invention.

FIG. 25 is an illustration showing the appearance of a counting system in the fourth embodiment.

FIG. 26 is an illustration showing an intrusion detection area AR in the images captured by a camera according to the time difference.

FIG. 27 is a block diagram showing the hardware structure of the counting system in the fourth embodiment.

FIG. 28 is a block diagram showing the structure of an image processing system in a fifth embodiment of the present invention.

FIG. 29 is a block diagram showing the structure of an image processing system in a sixth embodiment of the present invention.

FIG. 30 is a block diagram showing the specific structure of a character recognizing unit.

FIG. 31 is a block diagram showing the structure of a computer which executes programs.

FIG. 32 is an illustration for describing a process according to the time difference method.

FIG. 33 is an illustration for describing a process according to the background difference method.

FIG. 34 is an illustration for describing incorrect detection resulting from a deviation in the image-capturing position between the reference image and the image captured at the current time.

FIG. 35 is an illustration for describing incorrect detection in the case where there is a change in illumination conditions between the reference image and the image captured at the current time.

### DESCRIPTION OF THE PREFERRED EMBODIMENTS

First Embodiment

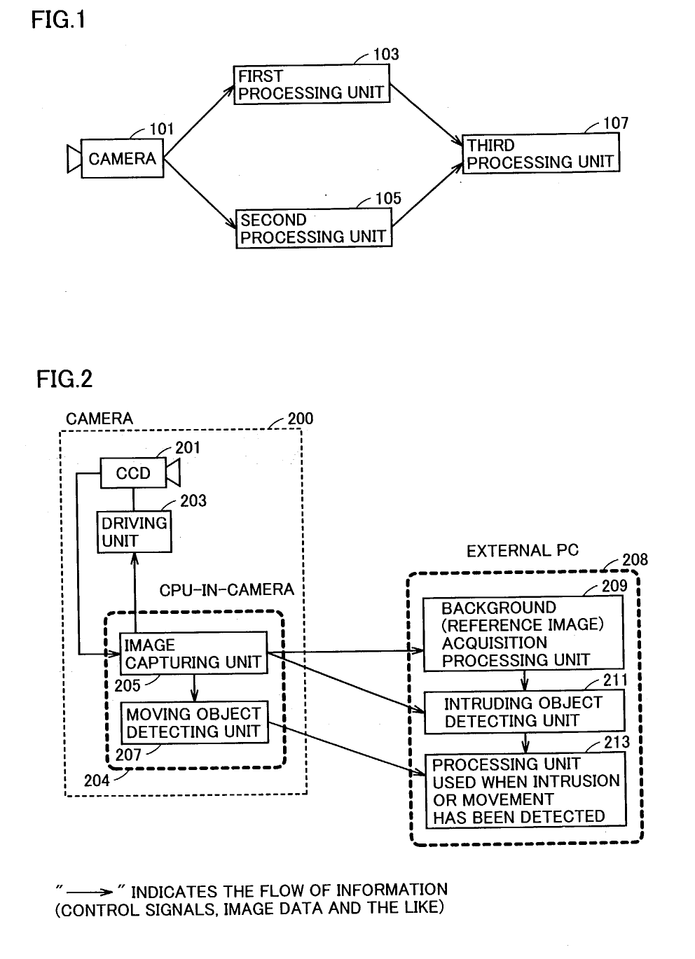

With reference to FIG. 1, an image processing system includes: a camera 101; a first processing unit 103 and a second processing unit 105 which receive image information from camera 101, respectively; and a third processing unit 107 which performs a third process based on the outputs of first processing unit 103 and second processing unit 105.

This image processing system performs monitoring intruders; counting the number of moving people; determining the presence or absence of a person; acquiring states of the operator of the device; and cutting out a character's region for character identification by using camera 101.

For example, a high-speed process required to have real-time property is carried out in first processing unit (first device) 103 so as to maintain the real-time property. On the other hand, a process required to have comparatively low real-time property in its importance (e.g., a comparatively time-consuming process) is carried out in second processing unit (second device) 105.

As necessary, third processing unit 107 carries out a process based on the outputs of first processing unit 103 and second processing unit 105.

Adopting this system structure brings about the following effects.

Leaving time-consuming processings to the second processing unit (a device having a CPU high in process speed (and transfer speed)) can improve the total performance in a system for carrying out plural processings (improvement in the whole processing time).

Leaving some of the processes (processes not demanding high processing speed) to another device can prevent an increase in the processing time required for such processes as must be operated at high speed (special emphasis is placed on the processing time required for such processes as must be operated at high speed and the minimum performance standards required to a camera CPU is reduced).

To be more specific, one such high-speed process which places special emphasis on real-time property and which is carried out by the first processing unit is moving-object detection by time difference. The processes which do not place special emphasis on real-time property and which are carried out by the second processing unit include intruding object detection by background difference; a counting process, a detailed object recognizing process, an action/posture recognizing process, and an identifying process for a detected intruding or moving object. It must be noted that some kinds of situations or applications place emphasis on real-time property in a background difference process, so that the above description does not restrict the processes to be carried out in the respective processing units.

To be more specific, the first processing unit can be a CPU in a camera, and the second processing unit can be a PC for image processing, another CPU in the camera, or a CPU in another camera.

Assume that both a background difference process which involves the correction of a positional deviation or an illumination change and a time difference process are executed in the system. The background difference process requires a long processing time of correction and the like. Therefore, this process is left to another CPU (the second processing unit), whereas a device (the first processing unit as the camera CPU) concentrates on motion detection by time difference which can be operated at high speed. With this configuration, a high-speed moving object, which is captured by the camera during the execution of a time-consuming background difference process, can be detected by time difference. On the other hand, an object moving at low speed which cannot be detected by time difference can be detected by the background difference process (the moving speed is too low to get the object out of the captured region before the preceding background difference process is complete).

FIG. 2 is a block diagram showing the structure of the image processing system in a first embodiment of the present invention. This image processing system is mainly constituted of a camera 200 and an external PC 208 connected to camera 200.

As shown in the figure, cameral 200 includes a CCD 201, a driving unit 203 constituted of a lens for adjusting image-capturing positions or zooming of CCD 201 and a motor, and a CPU-in-camera 204. CPU-in-camera 204, which performs moving object detection by time difference, includes an image capturing unit 205 which controls driving unit 203 so as to capture desired images via CCD 201, and a moving object detecting unit 207 which performs intruding object detection by time difference with the use of time-series images.

It is desirable that the processes carried out in moving object detecting unit 207 are at comparatively high speed, and it is possible to use a motion detecting circuit for image signals as disclosed in Japanese Patent Laying-Open No. 8-46925.

External PC 208 performs intruding object detection by a background difference process (as well as the acquisition and production of the reference image necessary for the background difference process, and processes required when an object is detected). External PC 208 includes: a background acquisition processing unit 209 for acquiring a background (reference image); an intruding object detecting unit 211 which detects an intruding object through a background difference process; and a processing unit 213, when intrusion or movement of an object is detected, for performing processings corresponding thereto.

The processes in processing unit 213 include counting the number of people, starting the recording of images, operating a warning device, and identifying characters.

Since intrusion detection by background difference requires acquiring the background image as a reference, background acquisition processing unit 209 carries out a process therefor. The present invention does not depend on this acquisition method. It is possible to set as the background image an image captured at a time when it is certain that there is no intruding object, or to use other conventional well-known methods.

In terms of hardware, external PC 208 is constituted of a CPU, memory, a hard disk drive, an external interface device, an input device such as a keyboard, and a display device.

In FIG. 2, the solid-line arrows indicate the flow of information such as control signals and image data.

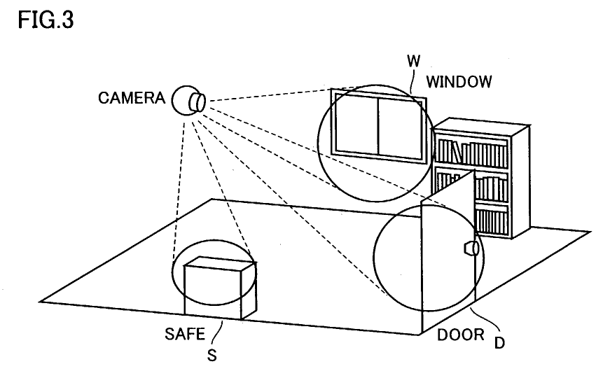

FIG. 3 is an illustration for describing the environments in which the image processing system is used. Assume that a single camera is controlled by driving unit 203 so as to monitor a plurality of positions in turns by changing the direction of the light axis, the focus, or zooming. The plurality of positions to be monitored are the positions of a window W, a door D and a safe S in the room.

In each monitoring position, it is continued to detect a moving object at predetermined time intervals by time difference. At the same time, the detection of an intruding object is carried out by comparing the captured images with the reference images containing no intruding object, the reference images being previously obtained for the respective monitoring positions.

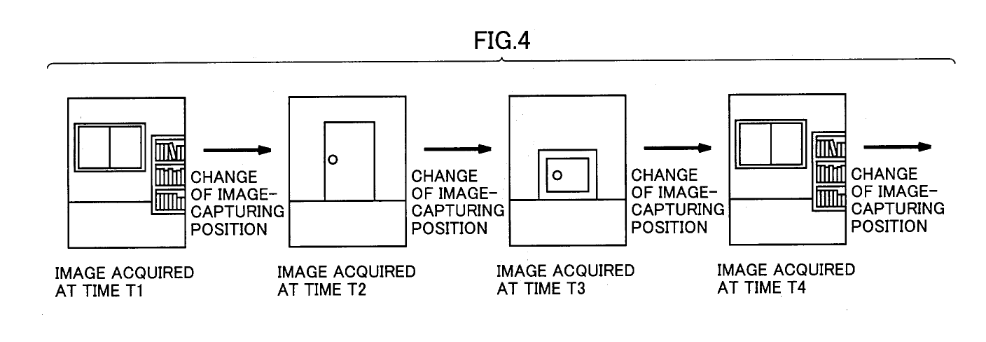

To be more specific, with reference to FIG. 4, the position of window W is captured at time T1; the position of door D is captured at time T2; and the position of safe S is captured at time T3. A sequence for making the rounds of these image-capturing positions is repeated to monitor the three locations in turn (which means that the position of window W is captured again at time T4).

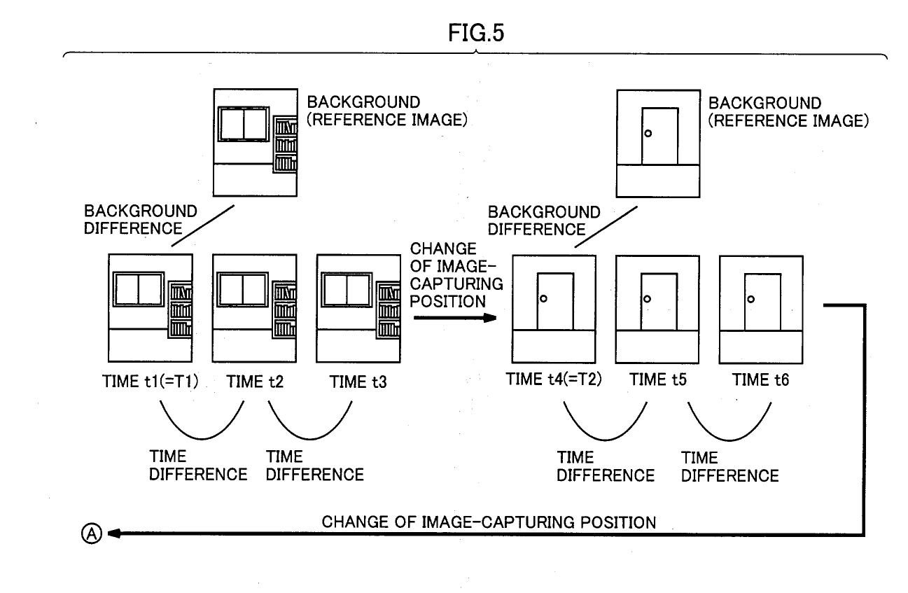

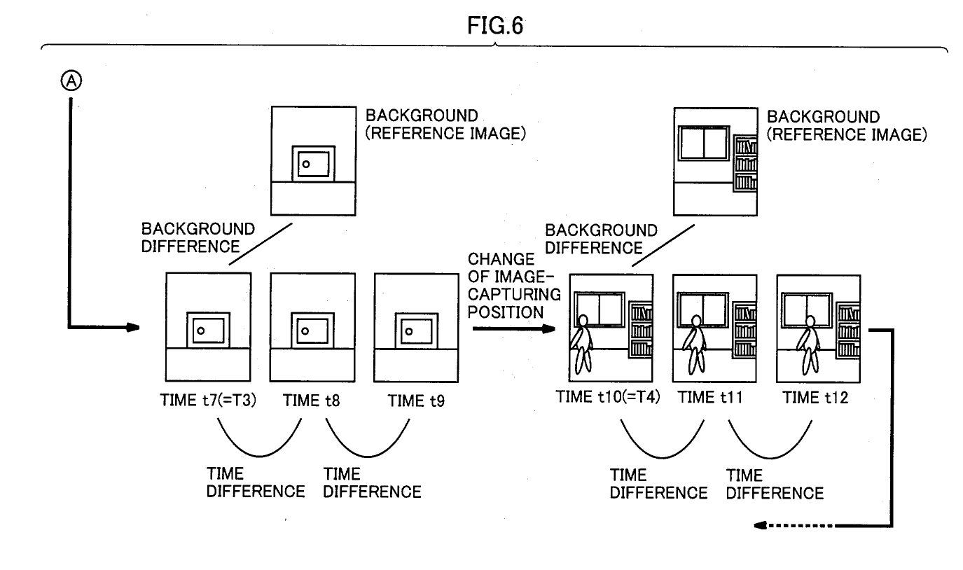

With reference to FIGS. 5 and 6, CCD 201 keeps capturing the position of window W from time t1 (=T1) to time t3.

While CCD 201 keeps capturing the position of window W, the image obtained at time t1 (=T1) by CCD 201 and the reference image are used to make external PC 208 carry out detection of an intruding object by background difference. CPU-in-camera 204 performs detection of an intruding object by time difference, while using the image obtained at time t1 by CCD 201 and the image obtained at time t2 by CCD 201. Then, CPU-in-camera 204 performs detection of an intruding object by time difference, while using the image obtained at time t2 by CCD 201 and the image obtained at time t3 by CCD 201. The detection is carried out under the conditions that time t1 (=T1)<t2<t3<t4 (=T2).

Between t4 (=T2) and time t6, CCD 201 keeps capturing the position of door D.

While CCD 201 keeps capturing the position of door D, the image obtained at time t4 (=T2) by CCD 201 and the reference image are used to make external PC 208 carry out detection of an intruding object by background difference. CPU-in-camera 204 performs detection of an intruding object by time difference, while using the image obtained at time t4 by CCD 201 and the image obtained at time t5 by CCD 201. Then, CPU-in-camera 204 performs detection of an intruding object by time difference, while using the image obtained at time t5 by CCD 201 and the image obtained at time t6 by CCD 201. The detection is carried out under the conditions that time t4 (=T2)<t5<t6<t7 (=T3).

Between t7 (=T3) and time t9, CCD 201 keeps capturing the position of safe S.

While CCD 201 keeps capturing the position of safe S, the image obtained at time t7 (=T3) by CCD 201 and the reference image are used to make external PC 208 carry out detection of an intruding object by background difference. CPU-in-camera 204 performs detection of an intruding object by time difference, while using the image obtained at time t7 by CCD 201 and the image obtained at time t8 by CCD 201. Then, CPU-in-camera 204 performs detection of an intruding object by time difference, while using the image obtained at time t8 by CCD 201 and the image obtained at time t9 by CCD 201. The detection is carried out under the conditions that time t7 (=T3)<t8<t9<t10 (=T4).

As described above, in the case where a camera is installed for monitoring, plural spots can be monitored in turn by using a small number (one, for example) of cameras, thereby delivering increased economy.

In this case, there might be an intruder while a spot is being video shot. When this intruder moves at low speed or almost keeps still, it is impossible to detect the intruder by the time difference method. Such a low-speed intruding object can be detected by background difference.

In reality, it is difficult to move a camera once and then to return it to the original position without causing a deviation because of errors in camera control such as panning, tilting, rotating and zooming, or of the influence of deterioration in the camera or wind.

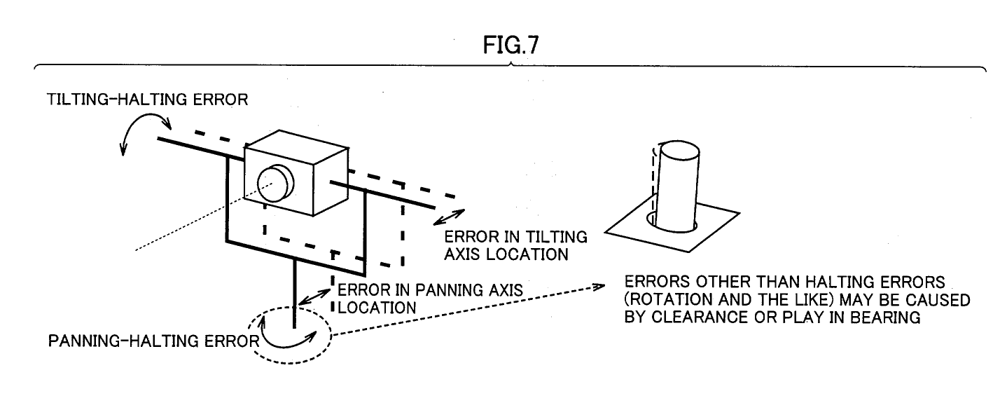

FIG. 7 is an illustration showing the outer appearance of a camera for monitoring different spots in turn. With reference to the illustration, in order to pan or tilt, the camera as a whole (or CCD) is rotated around the respective axes to face the light axis towards the desired position.

The method for controlling the direction of the light axis of the camera is not restricted to the panning and tilting. For example, it is possible to control the direction of the light axis of the CCD by shifting the camera as a whole in parallel; by changing the relative positional relation between the lens and the image pickup element; or by making use of a mirror or a prism. It is also possible to change the image-capturing region by rotation (rotating the light-axis direction) or zooming.

Different positional deviations generate differently depending on the type of the camera and the control method. The following is an example of an error caused by a positional deviation.

With reference to the left side of FIG. 7, there might be errors due to a deviation in the tilting axis or the panning axis, or errors in the halting position of the camera at the time of tilting or panning. With reference to the right side of FIG. 7, there might be errors by a clearance or play in the bearing.

Furthermore, there are other errors such as an error in zooming or an error in the inclination of the camera as a whole due to its deterioration or wind.

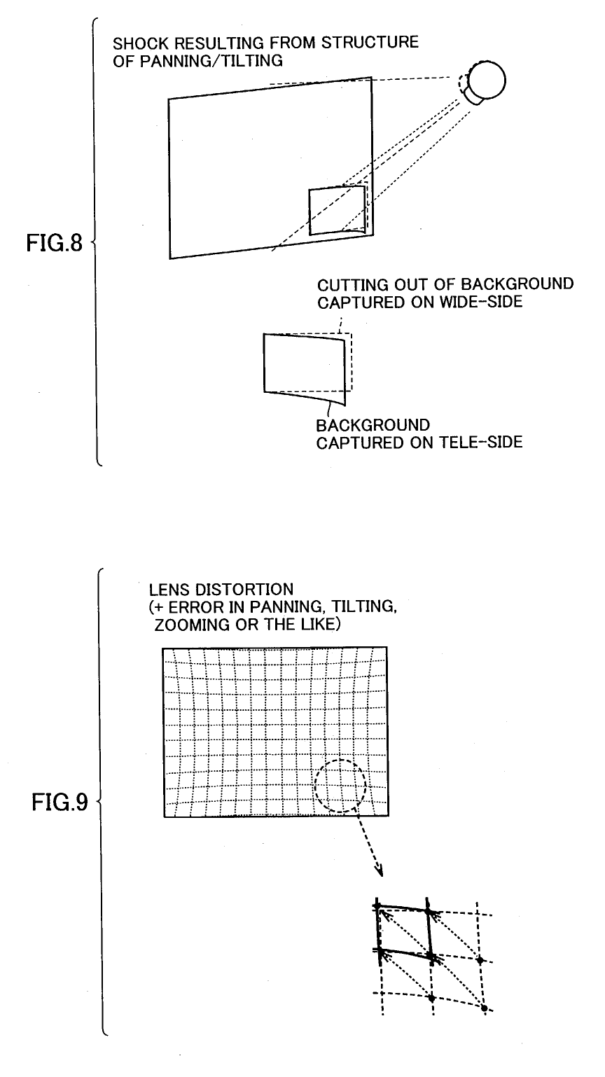

As shown in FIG. 8, there may be a shock error due to the structure of panning or tilting. Thus, a deviation can be caused depending on which part of the reference image is used.

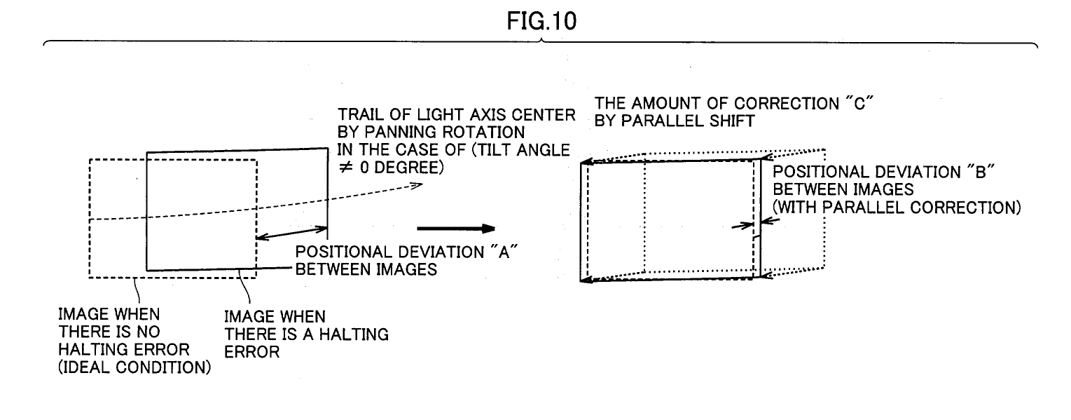

As shown in FIG. 9, there may be a positional deviation error resulting from lens distortion. As shown in FIG. 10, a rotation error in panning may cause a deviation and a shock. To be more specific, as shown in the left side of FIG. 10, there is a deviation “A” between the ideal condition without a halting error of the camera and the case with a halting error. As shown in the right side of FIG. 10, even if this deviation is corrected by the mere parallel shift of “C”, there is still a deviation “B” due to the shock.

Performing background difference requires correcting the above-mentioned positional deviation. The following is a description of the correcting method (the structure and effects of the present invention are not restricted to the method for correcting positional deviations).

In the present embodiment, the detection of a positional deviation is carried out by a matching using the image features or the amount of local features. The positional deviation can happen due to various causes such as a shock distortion or lens distortion; however, it is not realistic to detect them individually. Therefore, in the present embodiment, a positional deviation is detected by approximating it to affine transformation (parallel shift and rotation, in particular). The original image as the correcting target is deformed and corrected according to the affine transformation indicating the detected positional deviation so as to correct the positional deviation.

The problem here is that the purpose of a processing by the background difference method is to detect an intruding object, so a positional deviation must be detected by taking the probability of an intruding object into consideration.

Therefore, in the present embodiment, the detection of a positional deviation is carried out by excluding regions where there is high possibility that an intruding object may exist (potential intruding object regions) from a matching target.

The following is a description about the exclusion.

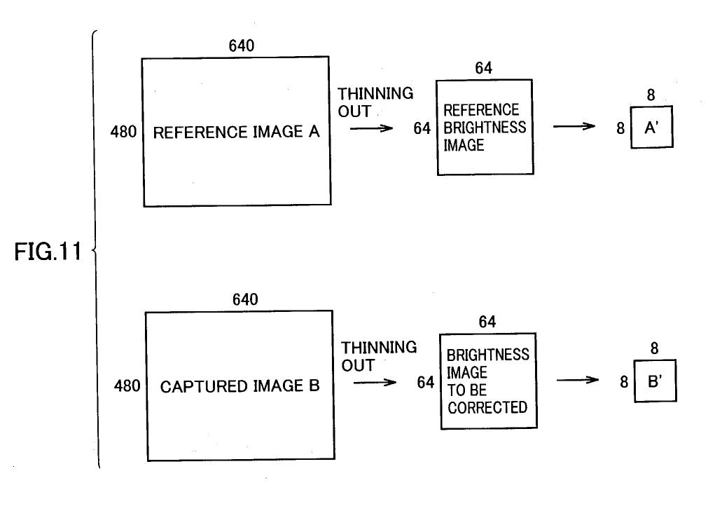

With reference to FIG. 11, assume that a reference image (reference background frame) “A” and a captured image (process target frame) “B” each have a size of 640×480 pixels. By thinning out the pixels of these images, a reference brightness image consisting of 64×64 pixels and a brightness image to be corrected also consisting of 64×64 pixels are formed. These brightness images are further reduced to the size of 8×8 pixels by BL (Bi-Linear) method so as to produce reduced images A′ and B′ for searching potential intruding object regions.

When the inter-frame difference between reduced images A′ and B′ is calculated and the difference value is not smaller than a threshold value “Th” which is previously set at a low level, the region is counted as an intruding object area (potential intruding object region). When the number is very large, the threshold is regarded as inappropriate, and the threshold value is slightly raised. Then the operation to count the intruding object areas is repeated. While repeating this operation, the intruding object areas are narrowed down to five. Note that when the threshold value becomes too high, the excluding process is completed.

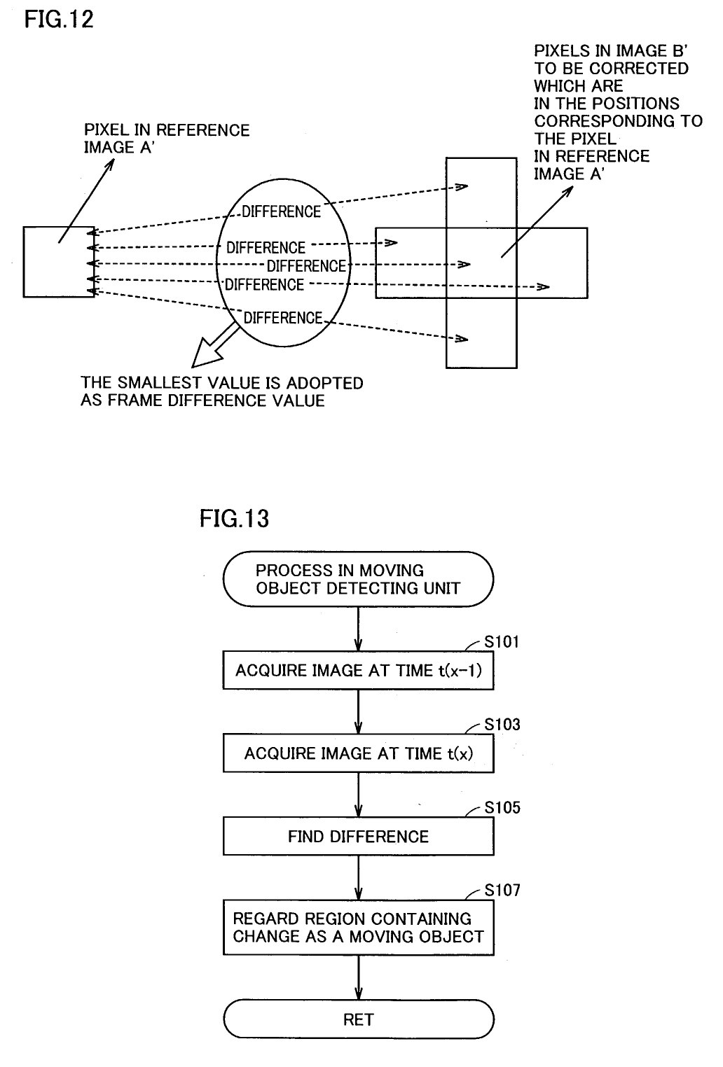

As shown in FIG. 12, the difference value is found for each of the five pixels in total in reduced image B′, one pixel corresponding to the pixel of interest in reduced image A′ and the other four pixels being adjacent to this pixel in the horizontal and vertical directions, while taking the case where there is an angular error between frames into consideration. The one having the smallest absolute value among them is selected as the difference value of the pixel of interest.

The potential intruding object regions thus obtained are subjected to a dilation processing of a width 1 so as to make them the final potential intruding object regions.

Then, the detection of a positional deviation is performed by being approximated by affine transformation. The searching range (−4[pix] to 4[pix] for parallel shift, and −2[degrees] to 2[degrees] for rotation angle) is set in advance. Under each requirement sampled (for example, −4, −2, 0, 2, 4 [pix] for parallel shift, and −2, −1, 0, 1, 2 [degrees] for rotation angle), the frame as the processing target is subjected to a processing (reduction+deformation+second differential extraction), so as to select a combination of parallel shift and rotation angle requirement which has the smallest frame difference value in total (except the potential intruding object regions) with the reference image. Then the original frame image to be processed is transformed and corrected.

Thus, in the present embodiment, regions which have a low chance of an intruding object are detected first by using each frame image in time-series images and the reference image. Then, positional deviation information between each frame image and the reference image is detected by using the information about these regions only. Intruding object regions are extracted by making use of the detected positional deviation information according to the background difference method.

Using this method has the effect of being able to detect an intruding object by the conventional background difference method even when there is a positional deviation. Because of the larger amount of information, detecting a moving object region after positional deviation detection has higher detecting performance than detecting the moving object region without positional deviation detection.

The processings executed by the respective processing units will be described as follows, with reference to the flowcharts.

FIG. 13 is a flowchart showing the intruding object detection process according to the time difference method which is performed by moving object detecting unit 207 of CPU-in-camera 204.

With reference to the flowchart, in step S101 the image at time t (x−1) is acquired. In step S103 the image of the next time t(x) is acquired. In step S105 the difference between both images acquired is found to obtain the changed region. In step S107 the changed region is regarded as the part including an intruding object (moving object). The processings in steps S101 to S107 are repeatedly executed at the predetermined time intervals.

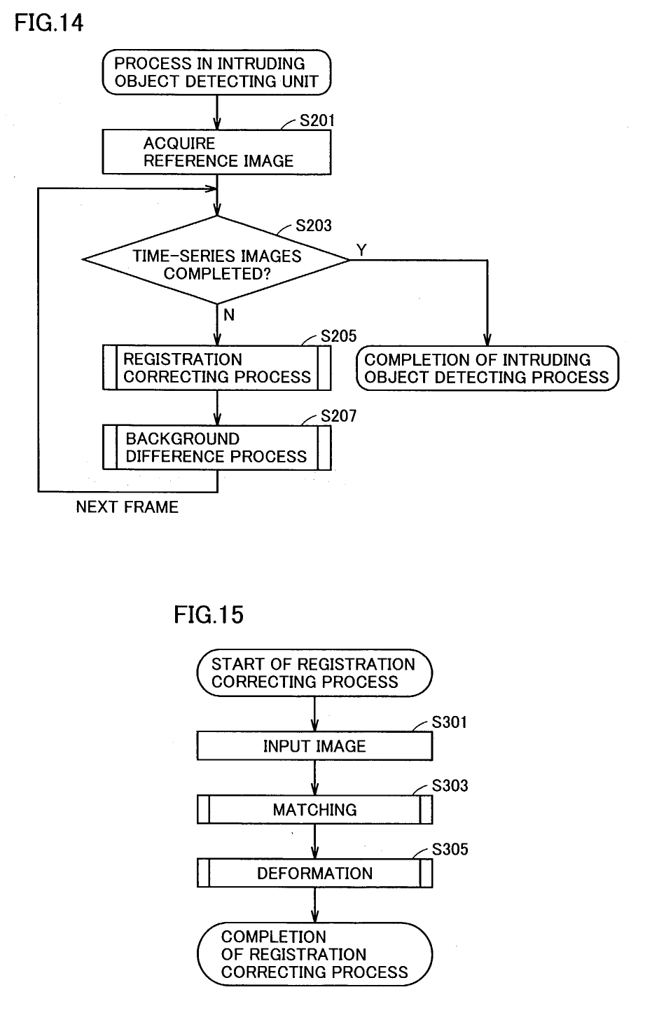

FIG. 14 is a flowchart showing the process performed by intruding object detecting unit 211 of external PC 208.

In the flowchart, in step S201 the reference image is acquired. In step S203 it is determined whether or not there is an input of time-series images (captured images) from the camera. When there is not, this routine is terminated, and when there is, a registration correcting process is performed in step S205. This correcting process corrects a deviation between the images before the background difference is found. The detailed procedures of the registration correcting process will be described later.

In step S207 a background difference process is applied to the image that has undergone the correction process, so as to return to step S203.

As one example of the method for acquiring the reference image in step S201, the image captured at a time when it is certain that there is no intruding object can be stored and used as the reference image as it is c (as mentioned earlier, the present invention does not depend on the method for acquiring the background image).

FIG. 15 is a flowchart showing the procedure of the registration correcting process (S205) shown in FIG. 14.

In the flowchart, the reference image and the captured image are inputted in step S301, and a matching process for these images is performed in step S303. In step S305 at least either one of the images is deformed when necessary, based on the results of the matching.

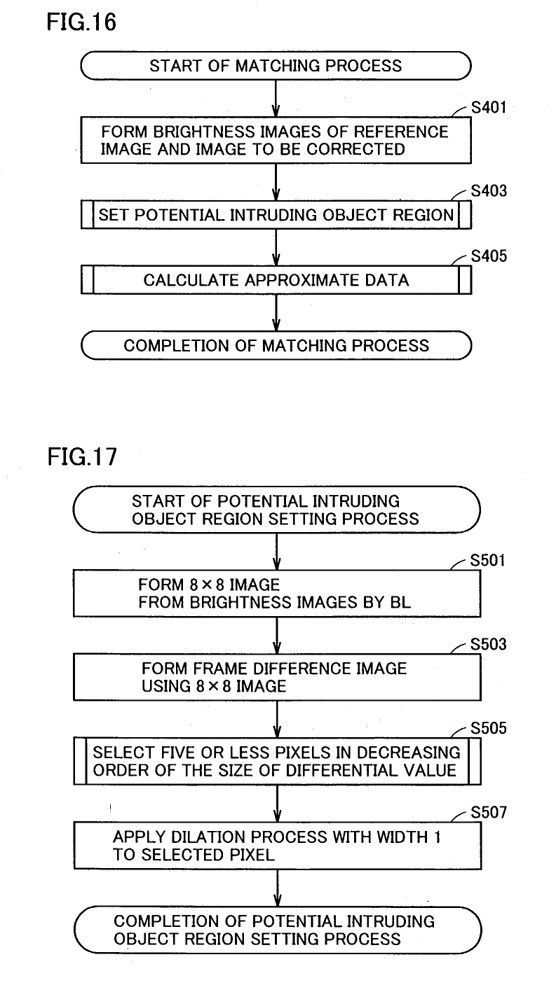

FIG. 16 is a flowchart showing the procedures of the matching process (S303) shown in FIG. 15.

In the flowchart, in step S401 the brightness images of a reference image and a captured image (also referred to as an image to be processed because the captured image is a correcting target here) are formed. As described with reference to FIG. 11, this process prepares images each having a size of 64×64 pixels by thinning out the pixels of the captured image and the reference image. In step S403 a process for setting the regions (potential intruding object regions) where there is high possibility that an intruding object exists is carried out by using the brightness images.

In step S405, data to approximate the amount of deviation between the images (data for affine transformation in this embodiment) is calculated.

FIG. 17 is a flowchart showing the procedures of the potential intruding object region setting process (S403) shown in FIG. 16.

In the flowchart, in step S501, images A′ and B′ (see FIG. 11) each consisting of 8×8 pixels are prepared by BL method from the two brightness images formed in step S401. In step S503 a frame difference image is prepared by finding the differences of the corresponding pixels between images A′ and B′. As described with reference to FIG. 12, this is not a mere calculation of difference, but the case where there is an angular error between frames is taken into consideration. To be more specific, assume that a certain pixel in image A′ is the pixel of interest, the difference value is found for each of the five pixels in total in image B′, one pixel corresponding to the pixel of interest in image A′ and the other four pixels being adjacent to this pixel in the horizontal and vertical directions. And the one having the smallest absolute value among them is selected as the difference value of the pixel of interest.

In step S505 five or less pixels are selected in decreasing order of the size of the differential value. In step S507 the selected pixels are subjected to a dilation process of a width 1. As a result, the regions containing the intruding object can have enough room.

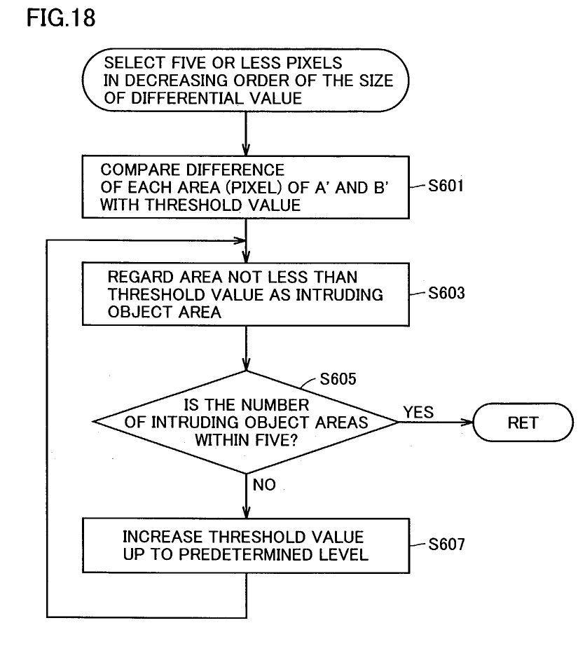

FIG. 18 is a flowchart showing a process for selecting five or less pixels in decreasing order of the size of the differential value shown in FIG. 17.

With reference to the flowchart, in step S601 the difference of each area of 8×8 pixels between images A′ and B′ is compared with the threshold value. In step S603 the areas having a difference not less than the threshold value are regarded as intruding object areas. In step S605, it is determined whether the number of the intruding object areas is within five, and when the result is YES, the routine returns to the process shown in FIG. 17. When the result is NO, the threshold value is increased up to the predetermined level in order to narrow down the number of the intruding object areas, and the routine returns to the process in step S603.

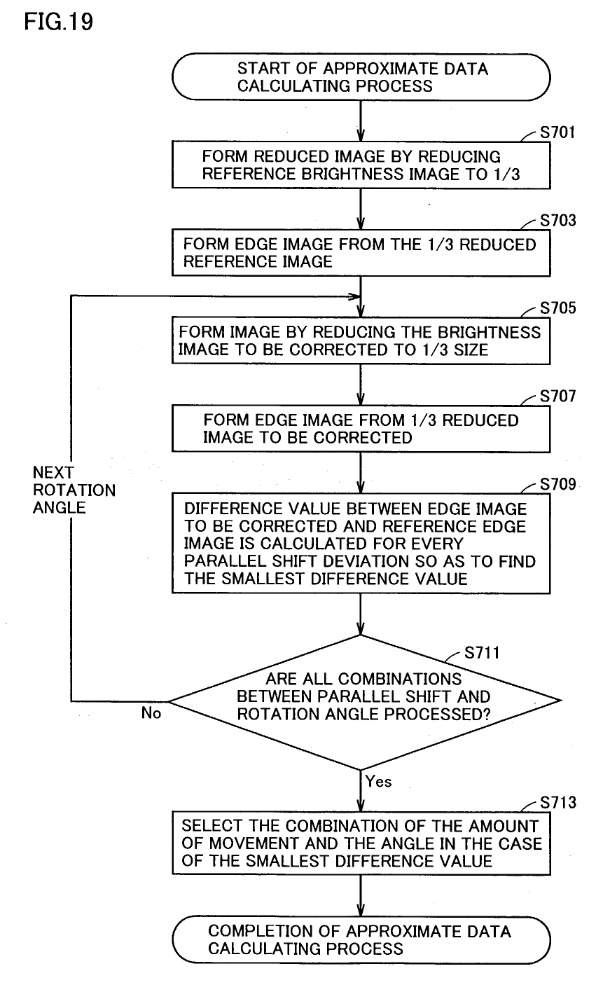

FIG. 19 is a flowchart showing the procedures of the approximate data calculating process (S405) shown in FIG. 16.

In the flowchart, in step S701 a reduced image (referred to as a “⅓ reduced reference image”) is formed by reducing the reference brightness image (see FIG. 11) consisting of 64×64 pixels to ⅓ size. In step S703 an edge image (referred to as a “reference edge image”) is formed from the ⅓ reduced reference image.

In step S705 a reduced image (referred to as a “⅓ reduced image to be corrected”) is formed by reducing the brightness image to be corrected (see FIG. 11) consisting of 64×64 pixels to ⅓ size. In step S707, an edge image (referred to as “edge image to be corrected”) is formed from the ⅓ reduced image to be corrected.

In step S709 the relative positional relation between the edge image to be corrected and the reference edge image is shifted in parallel to find the difference value between the images. The amount of shift is changed and the difference value between images is calculated for every possible parallel shift deviation, and the smallest value among them is found. As mentioned above, to perform a matching by using the potential intruding object regions is meaningless and rather increases the error, so the potential intruding object regions are excluded from the target for determination.

In step S711 it is determined whether the process is complete for all combinations of parallel shift amount and rotation angle. When the result is NO, the relative positional relation between the edge image to be corrected and the reference edge image is rotated, so as to repeat the processes from step S705 onward for the next rotation angle.

When the result is YES in step S711 the combination of the shift amount and the angle which becomes the smallest difference value is selected so as to make it the approximate data for affine transformation.

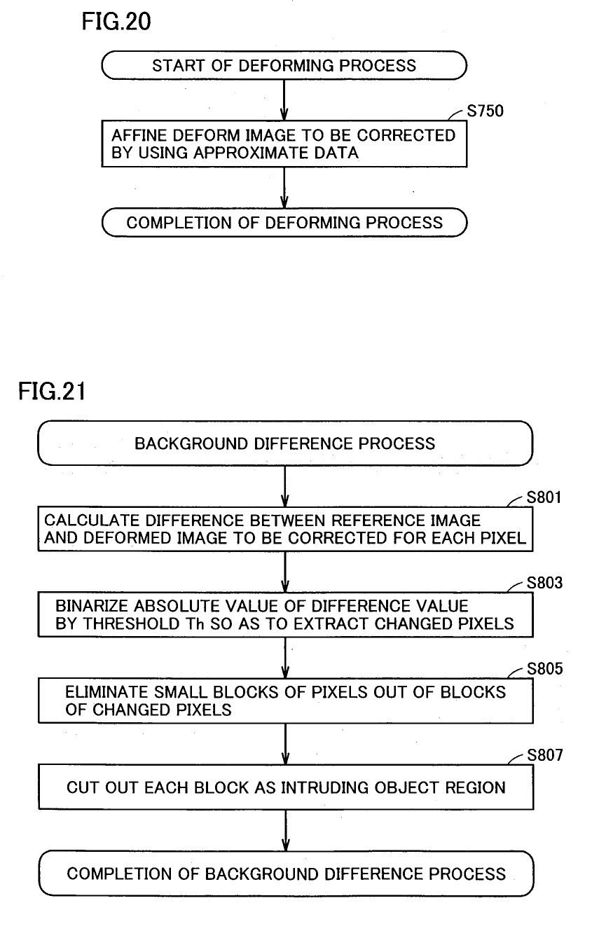

FIG. 20 is a flowchart showing the procedures of the deforming process (S305) shown in FIG. 15.

In the flowchart, in step S750 the affine transformation is performed on the image to be corrected by using the approximate data. This can eliminate the deviation between the reference image and the captured image.

FIG. 21 is a flowchart showing the procedures of the background difference process (S207) shown in FIG. 14.

In the flowchart, in step S801 the difference value is calculated for each pixel in the reference image and in the image to be corrected which has undergone deformation. In step S803 the absolute value of the difference value is binarized by using threshold “Th” so as to extract pixels having changes as compared with the reference image. In step S805 out of the extracted blocks of pixels, small blocks are eliminated as noise. In step S807 the extracted blocks of pixels are cut out as the moving object regions.

As described above, according to the present invention, it becomes possible to provide a method for keeping character detection without omission, while making external PC carry out a time-consuming processing.

It also becomes possible to prevent a decrease in the process speed of the time difference method resulting from the combined use of the time difference method and the background difference method.

In a situation as described in the present embodiment where a camera is operated and image-capturing positions are changed frequently, pointing the camera again at a position which has been pointed before is often accompanied by positioning error, thereby requiring an error correcting process. The method of the present embodiment can effectively cope with the process time increased by such a correcting process.

Although background difference and time difference are manipulated separately by different devices in the present embodiment, the following variations are possible. It is preferable that the detection of the intrusion and movement of an object is processed in real time continuously in time. On the other hand, in higher recognition processings such as counting the number of people, motion understanding, and character identification, the information about the processed results are highly valued whereas real-time property is not valued every much. This is the reason why these processes are carried out by different processing devices.

Second Embodiment

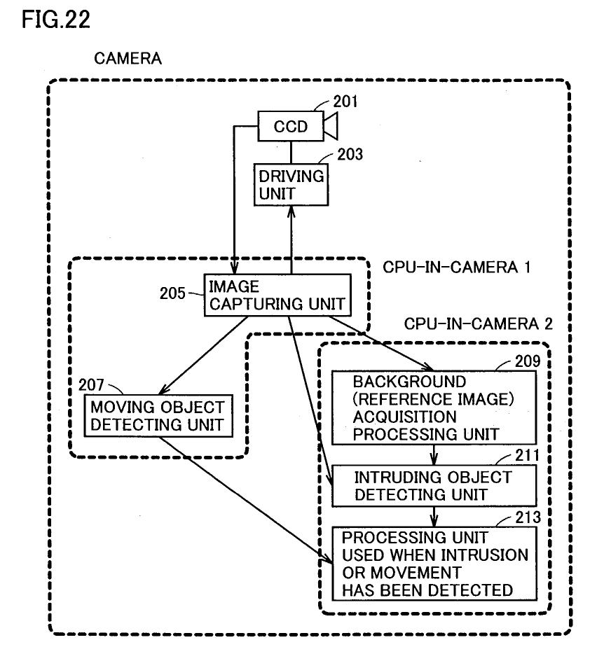

FIG. 22 is a diagram showing the structure of an image processing system in a second embodiment of the present invention. This image processing system differs from the system in the first embodiment in providing another CPU in the camera (CPU-in-camera 2) instead of external PC.

As shown in the figure, the camera includes a CCD 201, a driving unit 203 composed of a lens for adjusting image-capturing positions or zooming of CCD 201 and a motor; a CPU-in-camera 1; and a CPU-in-camera 2 which is different from CPU-in-camera 1. CPU-in-camera 1, which performs moving-object detection by time difference, is composed of an image capturing unit 205 which controls driving unit 203 so as to capture desired images via CCD 201, and a moving object detecting unit 207 which performs intruding object detection by time difference with the use of time-series images.

CPU-in-camera 2 performs intruding object detection by a background difference process (as well as the acquisition and production of the reference image necessary for the background difference process, and processings required when an object is detected). CPU-in-camera 2 includes a background acquisition processing unit 209 for acquiring a background (reference image); an intruding object detecting unit 211 which detects an intruding object through a background difference process; and a processing unit 213 which, when intrusion or movement of an object is detected, performs processings corresponding thereto.

The processes performed in the respective processing units are the same as those in the first embodiment, so their description will not be repeated here.

The present embodiment can provide a system capable of keeping character detection without omission, while performing a time-consuming processing at the same time.

It also becomes possible to prevent a decrease in the process speed of the time difference method resulting from the combined use of the time difference method and the background difference method.

Third Embodiment

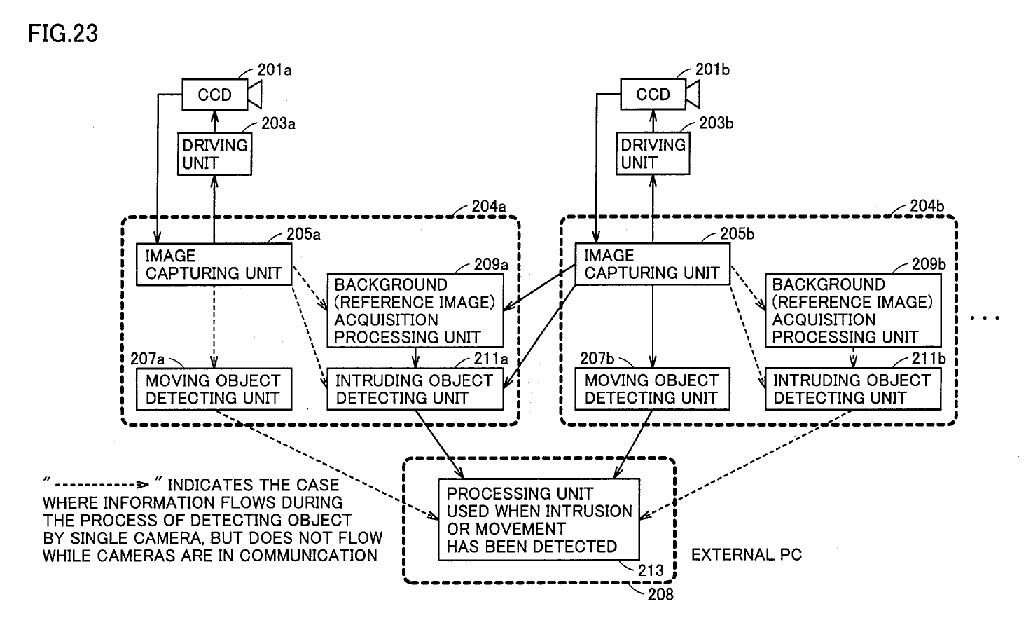

FIG. 23 is a block diagram showing the structure of an image processing system in a third embodiment of the present invention. This image processing system includes plural cameras 204a, 204b, . . . , which can perform motion detection by time difference and intrusion detection by background difference; and an external PC 208 which operates based on the instruction coming from the cameras when the intrusion or movement of an object has been detected. When a movement is detected by a camera, image information is transferred to the other cameras so as to detect the intrusion of an object.

To be more specific, in the figure, a camera includes CCDs 201a, 201b; driving units 203a, 203b each composed of a lens for controlling image-capturing positions or zooming of the CCD and a motor; and CPUs-in-camera 204a, 204b. CPUs-in-camera 204a, 204b perform moving object detection by time difference and intruding object detection by background difference. CPUs-in-camera 204a, 204b are respectively composed of image capturing units 205a, 205b which control driving units 203a, 203b so as to capture desired images via CCDs 201a, 201b, and moving object detecting units 207a, 207b which perform intruding object detection by time difference with the use of time-series images.

CPUs-in-camera 204a, 204b respectively further include background acquisition processing units 209a, 209b for acquiring a background (a reference image) and intruding object detecting units 211a, 211b for detecting an intruding object by a background difference process.

External PC 208 includes a processing unit 213 which operates when the intrusion or movement of an object has been detected.

In FIG. 23 the arrows indicate the flow of information and control signals. The dotted-line arrows indicate the case where information flows during the process of detecting an object by a single camera, but does not flow while the cameras are in communication.

The processes performed in the respective processing units are the same as those in the first embodiment, so their description will not be repeated here.

In the present embodiment, when a movement of an object is detected by a time difference process by a camera, image information is transferred to reference image acquisition processing units 209a, 209b and intruding object detecting units 211a, 211b in the remaining cameras so as to perform the background difference process. As a result, it becomes possible to prevent a decrease in the processing speed of the time difference method resulting from the combined use of the time difference method and the background difference method.

Fourth Embodiment

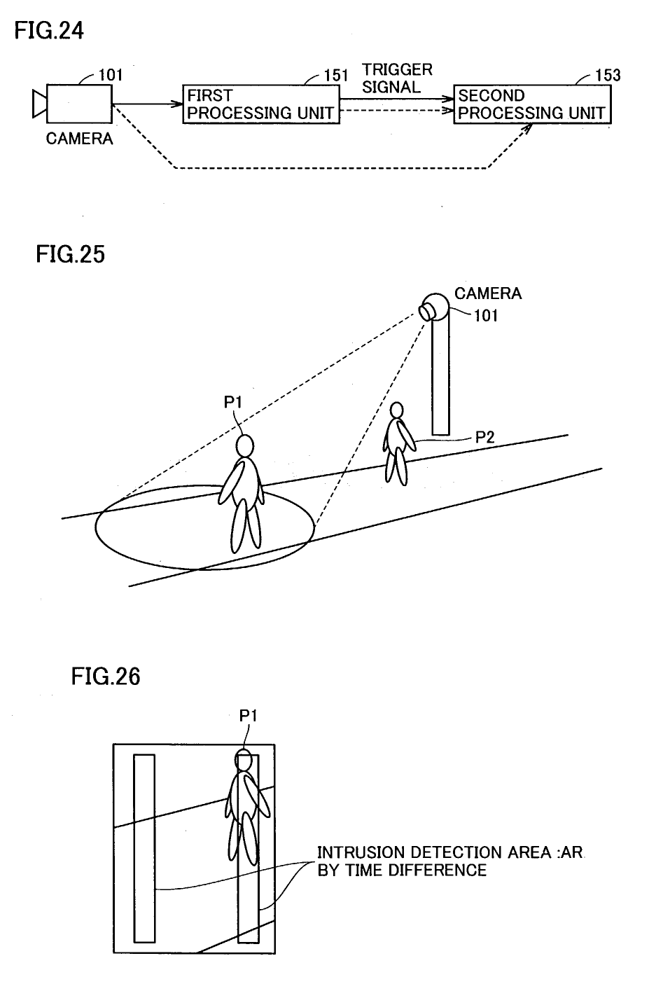

FIG. 24 is a block diagram describing the principle of an image processing system in a fourth embodiment of the present invention. As shown in the drawing, the image processing system includes a camera 101, and a first processing unit 151 and a second processing unit 153 which respectively receive image information from camera 101.

This image processing system performs monitoring intruders; counting the number of moving people; determining the presence or absence of a person; acquiring states of the operator of the device; and cutting out a character's region for character identification by using camera 101.

For example, a high-speed process required to have real-time property is carried out in first processing unit (first device) 151 so as to maintain being real time. On the other hand, a processing in which the real-time property is not valued very much and whose start is triggered by the processing results of first processing unit 151 (a comparatively time-consuming process) is carried out in second processing unit (second device) 153.

Adopting this system structure brings about the following effects.

Leaving time-consuming processings to the second processing unit (e.g., a device having a CPU high in processing speed (and transfer speed)) can improve the total performance (improvement in the whole processing time) in a system which carries out a plurality of processes.

Leaving some of the processes (processes not demanding high processing speed) to another device can prevent an increase in the processing time required for such processes as must be operated at high speed (special emphasis is placed on the process time required for such processings as must be operated at high speed and the minimum performance standards required to a camera CPU is reduced).

To be more specific, one such high-speed process which places special emphasis on real-time property and which is carried out by the first processing unit is moving-object detection by time difference. The processes which do not place special emphasis on real-time property and which are carried out by the second processing unit include intruding object detection by background difference; a counting process, a detailed object-recognizing process, an action/posture recognizing process, and an identifying process for a detected intruding or moving object. It must be noted that some kinds of situations or applications place emphasis on real-time property in a background difference process, so the above description does not restrict the processes to be carried out in the respective processing units.

To be more specific, the first processing unit can be a CPU in a camera, and the second processing unit can be a PC for image processing, another CPU in the camera, or a CPU in another camera.

FIG. 25 is an illustration showing the appearance of the counting system using the image processing system of the present embodiment. This system counts the number of people passing through the road.

This system is applied to the place where people do not stay for a long period of time continuously, such as in a shop or on a pedestrian road. In this system, intrusion detection is performed by a simple processing, and information including images is transferred to the other CPUs only when intrusion is detected, thereby determining whether the intruding object is a person or not, and counting the number when it is people. This system is in the form of dispersed processing.

In the case where both processes of intrusion detection and the determination as to whether it is a person or not are carried out by a CPU-in-camera, there is an inconvenience due to the processing performance of the CPU. To be more specific, when intrusion has been detected, the CPU is occupied during the determination as to whether the object in the intrusion region is a person or not. This makes it impossible to detect another intruding object.

In the present embodiment, the CPU-in-camera takes charge of processes which are desired to be operated continuously in real time (intrusion detection), whereas another CPU takes charge of processes (such as the counting of the number of people or the determination as to whether it is a person or not) which do not require a real-time processing (which can be calculated during a free time of the CPU without causing a serious problem).

Whether objects P1 and P2 have entered into the image-capturing region of camera 101 or not is determined by the CPU-in-camera according to the time difference method.

With reference to FIG. 26, in order to realize high-speed processing, the present embodiment provides an intrusion detection area AR in the image captured by camera 101 by time difference, and this area is exclusively used for detection by time difference.

The intrusion detection area AR is band-shaped. Intrusion is detected by a time difference processing (calculation of difference+processing of a threshold value+calculation of an intruding area) in this region. When intrusion is detected, another CPU determines whether it is a person or not, and when it is a person, the count value is incremented by 1.

Whether it is a person or not could be determined by various kinds of well-known methods such as using face detection, using skin color detection, or using information about the shape of the intruding region, based on the image acquired immediately after the intrusion detection transferred from the CPU-in-camera. For example, it is possible to use the method for character detection disclosed in Japanese Patent Laying-Open No. 2001-319217.

The position of the intrusion detection area AR is preferably matched with the position into which the person in the image is likely to enter. For example, when the image captured by camera 101 is the image at the position of the passage as shown in FIG. 25, area AR is so set as to catch people intruding from both directions of the passage as shown in FIG. 26.

Although time difference is used for the detection of an intruding object in this case, background difference could be used instead. The means for the detection of an intruding object is not restricted as long as it can be calculated at high speed.

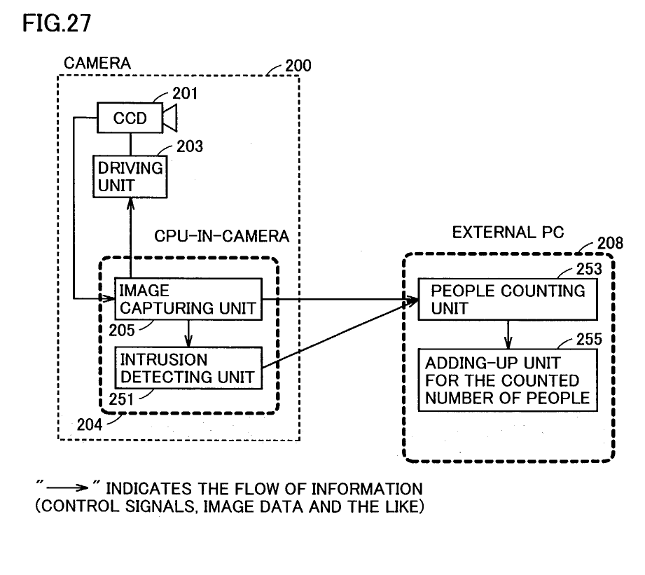

FIG. 27 is a block diagram showing the hardware structure of the counting system in the present embodiment. Like the first embodiment, the present system includes a camera 200 and an external PC 208.

As shown in the drawing, the camera includes a CCD 201, a driving unit 203 constituted of a lens for adjusting image-capturing positions or zooming of CCD 201 and a motor; and a CPU-in-camera 204. CPU-in-camera 204, which performs moving object detection by time difference, includes an image capturing unit 205 which controls driving unit 203 so as to capture desired images via CCD 201, and an intrusion detecting unit 251 which performs intruding object detection by time difference with the use of time-series images.

External PC 208 determines whether an intruding object is a person or not by being triggered by a signal transmitted from camera 200, which is indicative of the detection of the intruding object. External PC includes a people counting unit 253 for determining whether it is a person or not and counting the number of people, and an adding-up unit 255 for adding up the results of the counted number of people.

In the present embodiment thus structured, it becomes possible to provide a system capable of keeping character detection without omission, while a time-consuming processing is being carried out at the same time.

Fifth Embodiment

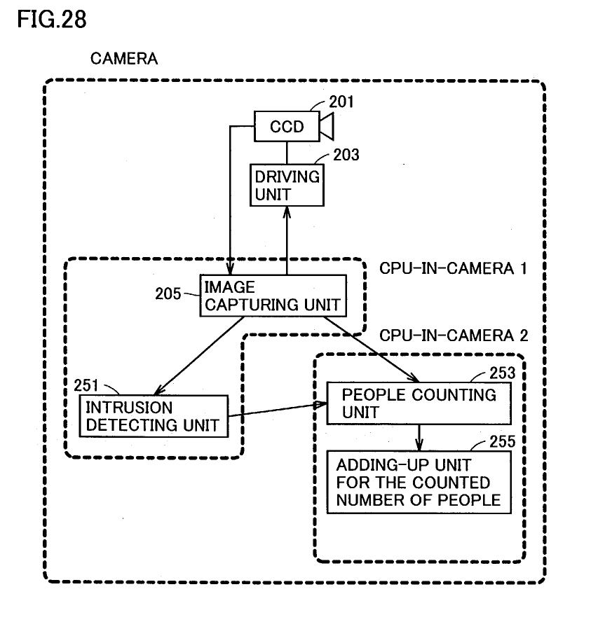

FIG. 28 is a block diagram showing the structure of a counting system using an image processing system in a fifth embodiment of the present invention. This system differs from the system (FIG. 27) in the fourth embodiment in providing another CPU in the camera (CPU-in-camera 2) instead of external PC.

As shown in the figure, the camera includes a CCD 201, a driving unit 203 constituted of a lens for adjusting image-capturing positions or zooming of CCD 201 and a motor; a CPU-in-camera 1; and a CPU-in-camera 2. CPU-in-camera 1, which performs moving object detection by time difference, is constituted of an image capturing unit 205 which controls driving unit 203 so as to capture desired images via CCD 201, and an intrusion detecting unit 251 which performs intruding object detection by time difference with the use of time-series images.

CPU-in-camera 2 determines whether an intruding object is a person or not by being triggered by a signal transmitted from CPU-in-camera 1, which is indicative of the detection of the intruding object, and when it is people, counts the number.

The processes performed in the respective processing units are the same as those in the fourth embodiment, so their description will not be repeated here.

In the present embodiment, it becomes possible to provide a system capable of keeping character detection without omission, while a time-consuming process is being carried out at the same time.

Sixth Embodiment

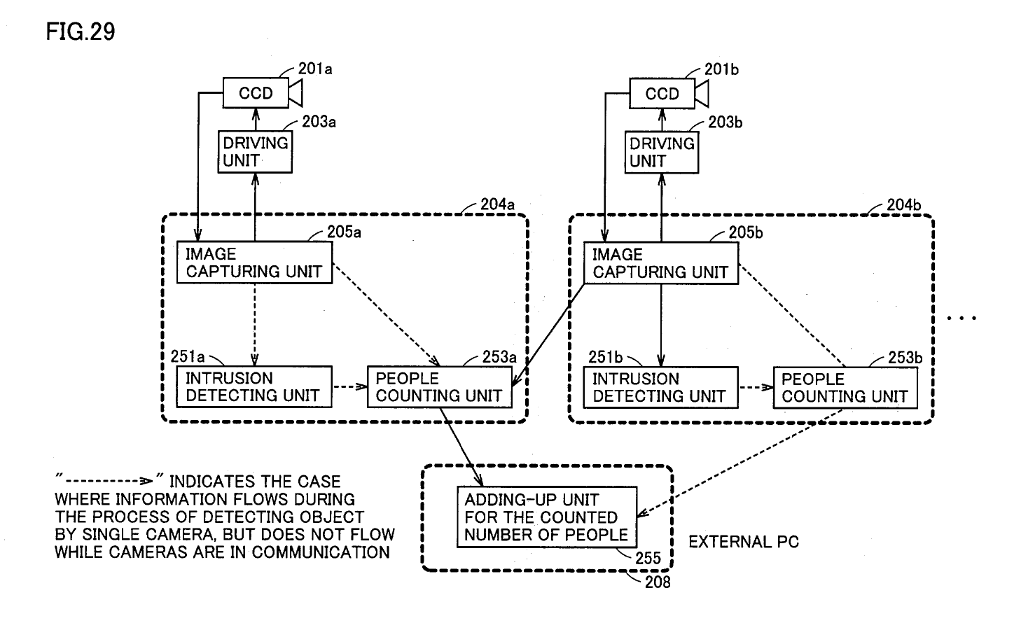

FIG. 29 is a block diagram showing the structure of an image processing system in a sixth embodiment of the present invention. This image processing system includes a plurality of cameras 204a, 204b, . . . , which can perform motion detection by background difference (or time difference), identify the image as a person, and count the number of people; and an external PC 208 which adds up the results of the counted number of people based on the instruction coming from the cameras. When the movement of an object has been detected by a camera, image information is transferred to the other cameras so as to determine whether it is a person or not and to count the number of people.

To be more specific, in the drawing, cameras 204a and 204b respectively include CCDs 201a, 201b; driving units 203a, 203b each composed of a lens for controlling image-capturing positions or zooming of the CCD and a motor; and CPUs-in-camera 204a, 204b. CPUs-in-camera 204a, 204b perform moving object detection by background difference and the determination as to whether an intruding object is a person or not by being triggered by a signal transmitted from another camera, which is indicative of the detection of the intruding object, and when it is people, count the number. CPUs-in-camera 204a, 204b are respectively composed of image capturing units 205a, 205b which control driving units 203a, 203b so as to capture desired images via CCDs 201a, 201b, and moving object detecting units 207a, 207b which perform intruding object detection by time difference with the use of time-series images.

CPUs-in-camera 204a and 204b further include people counting units 253a and 253b, respectively which determine as to whether it is a person or not and count the number of people.

External PC 208 includes an adding-up unit 255 for adding up the results of the counted number of people.

In FIG. 29 the arrows indicate the flow of information and control signals. The dotted-line arrows indicate the case where information flows during the process of detecting an object by a single camera, but does not flow while the cameras are in communication.

In the present embodiment, when the movement of an object has been detected by a camera through a background difference process, image information is transferred to people counting units 255a, 255b, . . . , in the other cameras so as to determine whether it is a person or not and to count the number of people. As a result, it becomes possible to prevent a decrease in the processing speed of the background difference method.

Others

A character recognizing unit can be provided in place of processing unit 213 in the first to third embodiments (see FIGS. 2, 22, and 23), people counting unit 253, and adding-up unit 255 in the fourth to sixth embodiments (see FIGS. 27 to 29) so as to recognize the detected person (the determination of who has been detected).

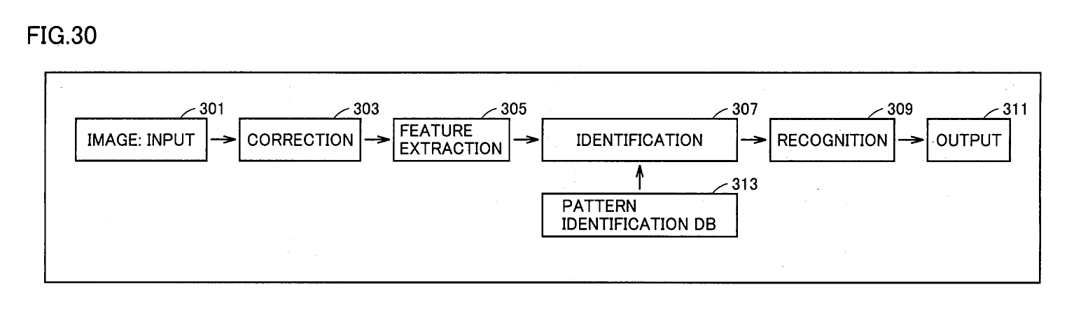

FIG. 30 is a block diagram showing a specific structure of the character recognizing unit.

As shown in the figure, the character recognizing unit includes: an input unit 301 for inputting images; a correcting unit 303 for performing image correction; an extracting unit 305 for extracting the amount of features in a corrected image; a pattern database 313 for storing a character in association with his/her features; an identifying unit 307 for searching the data stored in pattern database 313 based on the output of extracting unit 305, thereby identifying the features; a recognizing unit 309 for performing character recognition based on the identified results; and an outputting unit 311 for outputting the recognized results.

It is possible to provide a program for executing the processes in the flowcharts in the above-described embodiments, or to provide users with the program stored in a recording medium such as CD-ROM, a flexible disk, a hard disk, a ROM, a RAM, or a memory card. It is also possible to C download the program to a device over a communications line such as the Internet.

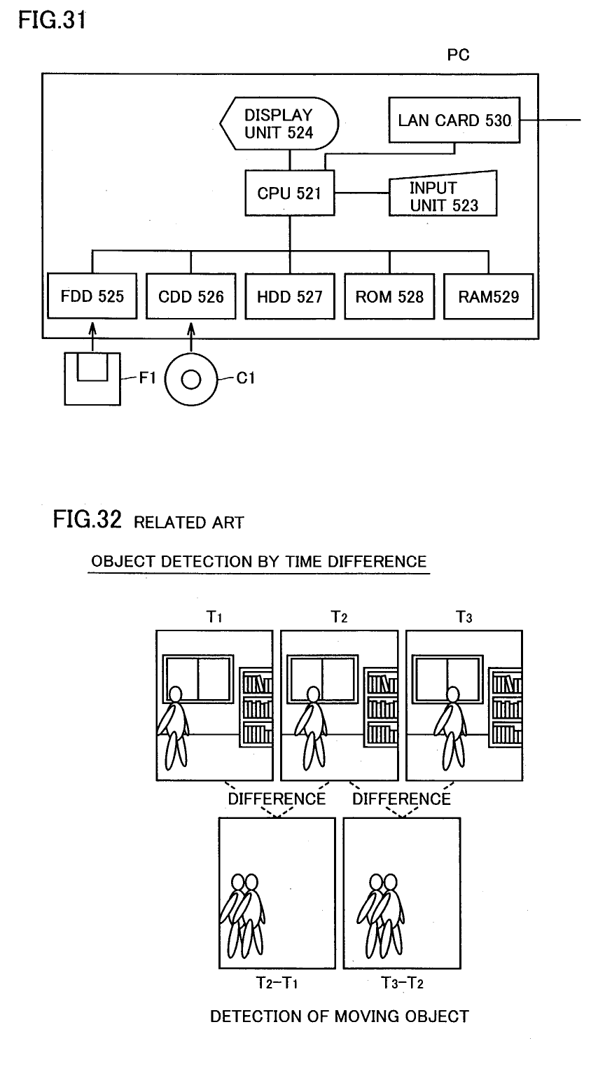

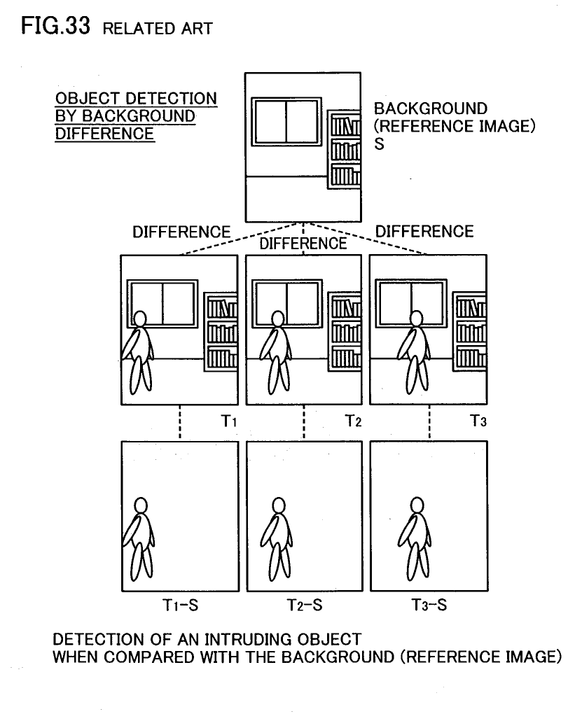

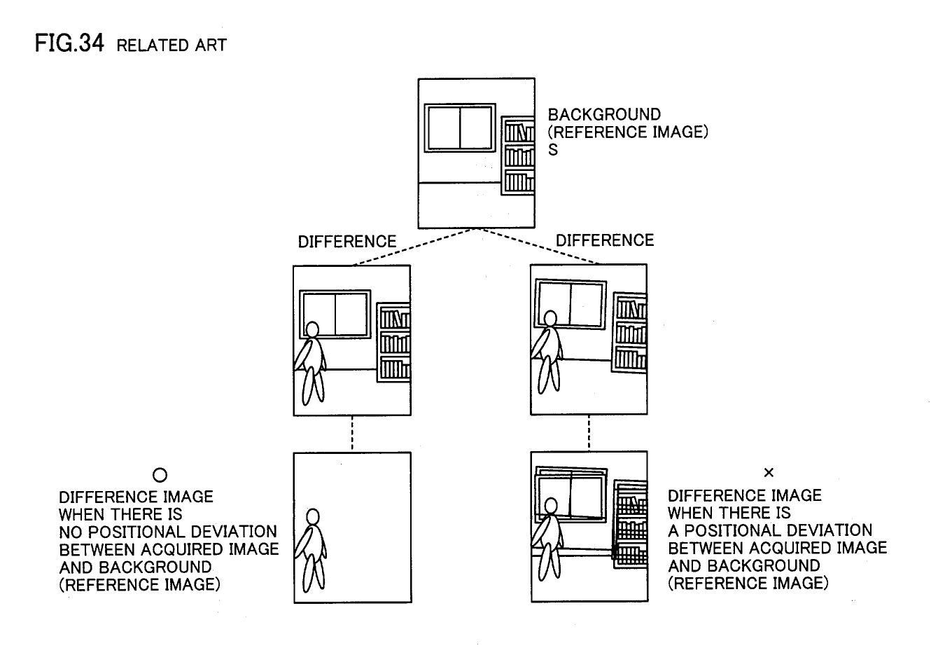

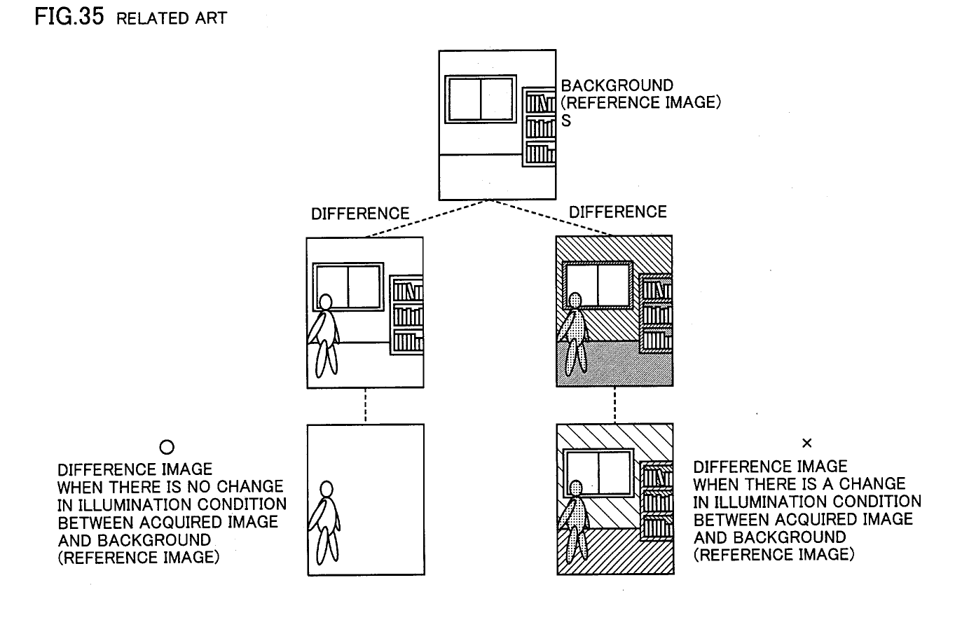

FIG. 31 is a block diagram showing the structure of a computer which executes such a program.

In the figure, the computer includes a CPU 521 which controls the entire device; a display unit 524, a LAN (Local Area Network) card 530 (or a modem card) which can be connected to a network or can communicate with an outside device; an input unit 523 which is constituted of a keyboard and mouse; a flexible disk drive 525; a CD-ROM drive 526; a hard disk drive 527; a ROM 528; and a RAM 529.

The program to drive CPU (computer) 521 shown in the flowcharts can be recorded in a recording medium such as a flexible disk or a CD-ROM (C-1). This program is transferred from the recording medium to a RAM or another recording medium to be recorded therein.

The processings of various types shown in the above-described embodiments can be performed either by software or by using a hardware circuit.

It is possible to provide a device formed by combining any of the above-mentioned embodiments.

In the above-described embodiments, images are inputted via cameras. Instead of this, already recorded images can be inputted from a storage device such as a video, a DVD, or a hard disk.

According to the aforementioned embodiments, it becomes possible to provide an intruding object detection device for detecting an intruding object by taking a deviation between the reference image and an image different from the reference image into consideration.

Since deviation detection is applied to regions having a low chance of an intruding object, the deviation detection can have high precision.

Since deviation correction is carried out by deforming and changing at least one of the reference image and the image different from the reference image, the burden of the processing can be reduced.

It also becomes possible to provide an intruding object detection device which effectively corrects image-capturing errors by a camera equipped with a driving mechanism.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An intruding object detection device comprising:
a processing unit for correcting a deviation between a first image and a second image and for detecting an intruding object, on the basis of the difference between the first and second images from which the deviation has been corrected,
wherein the first image is to be a reference image and the second image is different from the second image.

2. The intruding object detection device according to claim 1, wherein
said processor selects a region where there is low possibility that an intruding object exists in said second image, detects a deviation between the first and second images with regard to the selected region, and corrects the deviation between the first and second images on the basis of detection results.

3. The intruding object detection device according to claim 1, wherein
said processor transforms and corrects at least one of said first image and said second image, thereby correcting a deviation between the first and second images.

4. The intruding object detection device according to claim 1, further comprising:
a camera including a driving mechanism and capturing images, wherein
said processor acquires said first image and said second image from said camera, and
said camera drives said driving mechanism between the acquisition of said first image and the acquisition of said second image by said processor.

5. An intruding object detection method comprising the steps of:
(a) acquiring a reference image;
(b) acquiring an image different from said reference image;
(c) detecting a deviation between said reference image and the image different from said reference image; and
(d) detecting an intruding object from said reference image and the image different from said reference image by taking said detected deviation into consideration.

6. The intruding object detection method according to claim 5, wherein
said step (c) includes a step of selecting a region where there is low possibility that an intruding object exists in the image different from said reference image, and
the deviation found with regard to said selected region is regarded as a detected deviation.

7. The intruding object detection method according to claim 5, wherein
said step (d) includes the steps of:
(d1) deforming and correcting at least one of said reference image and the image different from said reference image, by making use of deviation information detected in said deviation detecting step; and
(d2) calculating the difference value between said reference image and the image different from said reference image after the completion of said deformation and correction, wherein
a region where an intruding object exists is detected on the basis of a pixel having a large difference value.

8. The intruding object detection method according to claim 5, wherein
said step (b) involves image acquisition by a camera including a driving mechanism, and
said camera is driven before acquiring the image different from said reference image.

9. An intruding object detecting program product for making a computer execute the steps of:
acquiring a reference image;
acquiring an image different from said reference image;
detecting a deviation between said reference image and the image different from said reference image; and
detecting an intruding object from said reference image and the image different from said reference image by taking said detected deviation into consideration.

10. A computer readable recording medium storing an intruding object detection program for making a computer execute the steps of:
acquiring a reference image;
acquiring an image different from said reference image;
detecting a deviation between said reference image and the image different from said reference image; and
detecting an intruding object from said reference image and the image different from said reference image by taking said detected deviation into consideration.
